(19) United States
(12) Patent Application Publication
(10) Pub. No.: US 2024/0160943 A1
(43) Pub. Date: May 16, 2024

(54) SYSTEMS AND METHODS FOR SOLVING MULTI-AGENT DECISION PROCESSES WITH NETWORK CONSTRAINTS

(71) Applicant: Salesforce.com, inc., San Francisco, CA (US)

(72) Inventors: Soham Phade, San Francisco, CA (US); Stefano Ermon, Menlo Park, CA (US); Stephan Zheng, Redwood City, CA (US)

(21) Appl. No.: 18/054,009

(22) Filed: Nov. 9, 2022

(51) Int. Cl. G06N 3/092

(52) U.S. Cl. CPC G06N 3/092

(57) ABSTRACT

Embodiments described herein provide systems and methods for solving and applying a multi-agent decision process. A system performs a process, where at each iterative step, the system determines policies for a plurality of agents that optimize respective reward values based on the plurality of costs, and the characteristics of the plurality of agents. The system simulates the multi-agent decision process using the determined policies, thereby generating respective reward values and aggregated resource contribution values. The system increments or decrements the plurality of costs based on the constraints and the aggregated resource contribution values. The system updates a final reward value based on the respective reward values. The system updates a final plurality of costs based on the plurality of costs. After performing the iterative step for a predetermined number of iterations, the system outputs the final reward value and the final plurality of costs.

### TECHNICAL FIELD

The embodiments relate generally to natural language processing and machine learning systems, and more specifically to systems and methods for solving multi-agent Markov Decision Processes (MDPs) with network constraints.

### BACKGROUND

Machine learning systems have been widely used in a lot of applications such as autonomous driving, customer service, booking system, and/or the like. An intelligent agent that is implemented on a machine learning system often need to make decisions while interacting with a human user to complete a task, e.g., whether to direct a conversation to a different topic, whether to route the caller to a different agent, and/or the like. Such decision processes can sometimes be solved via Markov Decision Processes (MDPs), where agents are coupled through network constraints over their actions. Traditional methods “solve” MDPs using linear programming (LP) techniques that become slow as the network's complexity grows. As such, they do not scale efficiently, and large networks become impractical to solve using traditional techniques.

Therefore, there is a need for improved systems and methods for solving multi- agent decision processes with network constraints.

### BRIEF DESCRIPTION OF THE DRAWINGS

FIG. 1 is a simplified diagram illustrating a decision process solving framework according to some embodiments.

FIG. 2 is a simplified diagram illustrating a computing device implementing the decision process solving method described in FIG. 4 according to one embodiment described herein.

FIG. 3 is a simplified block diagram of a networked system suitable for implementing the Decision Process solving framework described in FIG. 4 and other embodiments described herein.

FIG. 4A provides an example pseudo-code illustrating an example algorithm for solving a decision process, according to some embodiments.

FIG. 4B provides an example logic flow diagram illustrating an example algorithm for solving a decision process, according to some embodiments.

FIG. 5 illustrates an exemplary network according to some embodiments.

FIGS. 6-9B provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Machine learning algorithms are used to simulate and optimize dynamic systems, e.g., an economic network, an autonomous driving system, a customer service intelligent chatbot, etc. In such dynamic systems, a machine learning model based agent may decide a next-step action (e.g., generate a specific response, direct a conversation to a different topic, etc.) based on a policy, e.g., whether and how much to reward or penalize an action given the current state of the dynamic system. As the states of the dynamic system may evolve according to the actions the agent carries out, which in turn are decided according to the policy, an optimal policy that optimizes the rewards may often be desired.

For example, in a dynamic system that simulates the social economic dynamics, a policymaker may seek to optimize social expense structure to align agent incentives with social welfare in an economic network with resources, firms, and consumers. Such complicated social dynamics may be modeled by a multi-agent network such as machine learning networks, social networks, and communication network traffic and resource management. For example, a system with shared resources such as a communication network may be modeled and optimized. From a learning perspective, this requires solving large network decision processes such as Markov Decision Processes (MDPs), where agents are coupled through network constraints over their actions.

One technical challenge is that with an increasing number of agents or network topology complexity, it becomes harder and practically infeasible to design mechanisms, and for each mechanism, find the feasible solutions (and those that are game-theoretically optimal equilibria). Traditional approaches use linear programming (LP) techniques that become slow significantly and become impractical as the network's complexity grows.

In view of the need for improved approaches for solving large network Markov Decision Processes, embodiments herein provide for a scalable approach which combines multi-agent deep reinforcement learning (RL) and online optimization to find the optimal planner's policy (e.g., pricing policy) and the corresponding agent policies. The planner's policy is optimized so that agents acting in their own self-interest will result in an overall system-level optimal solution. The agent's behavior may be adjusted by the planner's policy, for example, by adjusting the cost of contributing/using resources. Specifically, in a network with N agents, and M resources, the agents are faced with determining an optimal strategy for a Markov Decision Process (MDP) given resource constraints, and agent-specific resource contribution and reward functions. A Markov Decision Problem (MDP) may include a state for each agent at each time step, a transition function that defines the probability of the agent arriving in each state for a given action, a reward function, and a resource contribution function. Given a set of states, actions, rewards, constraints etc., an agent may optimize their strategy to maximize their reward function. Note that in this application, “contribution” of a resource by an agent may be interpreted as production of the resource, or consumption/utilization of the resource.

In an example herein, networks are considered with multiple agents where each directed edge of the network between agents (nodes) means that an agent's actions affect the rewards and constraints of another agents. An exemplary network is discussed with respect to FIG. S. As an example, targeted climate policy design may be considered, i.e., designing a mechanism that distinguishes between different types of agents in the network to promote sustainability. Here, a reinforcement learning (RL) planner (mechanism designer) optimizes tax policy (the planner's problem) to meet limits on dirty energy usage in an economic network with firms and consumers (also RL agents). In this network, for example, edges may represent goods that flow from one firm (producing the good) to another firm or consumer (buying the good). An example constraint is market clearing, i.e., for each producer, the total number of goods bought (demand) equals or does not exceed the number of goods or resources available (supply). The planner's policy (setting the mechanism) then would set the optimal weights for each constraint (taxes that alter the price of goods), such that agents are incentivized to satisfy that constraint.

In other implementations, the multi-agent reinforcement learning network described herein may be widely applied in a number of applications, such as autonomous driving, wireless network management, multi-agent customer service system, and/or the like. For example, in a mobile network, various different applications, such as HTTP service, voice-of-IP service, peer-to-peer service, over-the-top streaming service, and/or the like, may compete for wireless bandwidth. Multiple RL agents may be implemented at a user device, a router, a gateway, and/or the like, which implements policies to allocate bandwidth to a specific application. The allocation policy may be optimized using the multi-agent network described herein to optimize user experience with Internet access.

In some embodiments described herein, a system performs a process, where at each iterative step, the system determines policies for agents that optimize respective reward values based on resource costs, and the characteristics of the agents. The determination of agent policies may be performed in a number of ways, including a reinforcement learning algorithm. The system then simulates the multi-agent decision process using the determined policies, thereby generating respective reward values and aggregated resource contribution values. The system increments or decrements the plurality of costs based on the constraints and the aggregated resource contribution values. If the aggregated contributions of a resource are above the constrained limit, then the price of that resource is incremented (effectively a gradient descent) in the planner's policy for the next iteration. This incremental adjustment allows for agents to be optimized and simulated in batches, improving the scalability of the algorithm.

The system updates a final reward value based on the respective reward values. After performing the iterative step for a predetermined number of iterations, the system outputs the final reward value and the final optimized costs. Final optimized costs may be determined by averaging the costs determined at each iteration, or by using the final cost at the last iteration.

Embodiments described herein provide a number of benefits. For example, large decision processes with network constraints may be solved more efficiently than alternative methods. The methods herein may be used to solve large networks faster than linear programming (LP) solvers, thereby requiring less time and/or compute resources. By solving in increments, agents may be optimized in batches, allowing for larger networks to be solved with a given system, and/or for decision processes to be solved using less system resources. The determined optimal values may be used in a number of systems. For example, a communication network with constrained resources may be controlled using values determined using the methods described herein, allowing for the communication network to function more efficiently, with a more optimal utilization of existing resources.

In a specific test of an embodiment of the methods described herein, on networks with 250 to 1000 agents, solving their resource-constrained multi-agent Markov decision process (CMMDP) using an embodiment of the methods described herein. To contrast, a state-of-the-art LP solver needs 3-4 minutes with 100 agents to converge for a single iteration. Moreover, the memory requirement is too large on a single A100 GPU with 200 agents or more in the network. As such, LP solvers become impractical in many settings.

### Overview

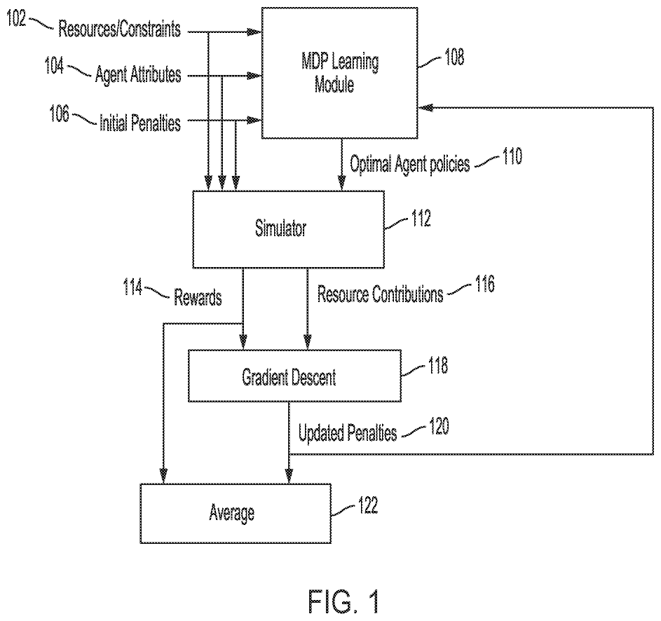

FIG. 1 is a simplified diagram illustrating a decision process solving framework 100 according to some embodiments. The framework 100 comprises MDP learning module 108 which is operatively connected to simulator 112. Simulator 112 is operatively connected to gradient descent 118 and average 122. Specifically, MDP learning module 108 has inputs of resources/constraints 102, agent attributes 104, and initial penalties 106. For example, the resources/constraints 102 may define the availability/scarcity of a resource in the network model (e.g., a total capital amount in an economic network, a total bandwidth available in a wireless network, etc.). Constraints may include, for example, restrictions on the use/production of certain resources (e.g., a bandwidth restraint on using over-the-top service in a wireless network, or a delay constraint, etc.).

In an energy resource context, the restriction may be on the amount of coal which may be used. In a communication network context, a constraint may include a communication bottleneck, or a limitation on how much bandwidth a device may use associated with a shared network component. Agent attributes 104 may include capability for producing and/or consuming resources, agent MDP policy, etc. Initial penalties 106 may be costs associated with using/producing resources, specifically a cost imposed by a planner's policy.

Given the initial resources/constraints 102, agent attributes 104, and initial penalties 106, MDP learning module 108 determines optimal agent policies 110. Numerous different MDP learning algorithms may be used as part of MDP learning module 108, including “no-regret” learning algorithms.

Simulator 112 receives the initial conditions in addition to the determined optimal agent policies 110 associated with those conditions. The network is simulated over a number of time steps in order to determine rewards 114 and resource contributions 116. The system may track rewards 114 and resource contributions 116 individually for each agent, and collectively for all agents.

Gradient descent 118 determines cost adjustments to the planner's policy (i.e., adjusting initial penalties 106 to provide updated penalties 120) based on the determined rewards 114 and resource contributions 116. Gradient descent 118 may also determine cost adjustments based on imposed network constraints. For example, a desired limit on resource contributions by agents may result in increasing the penalty associated with resource contribution if the simulator 112 determined that agents would exceed the limit. As opposed to linear programming (LP) methods, the optimal costs are not reached in a single pass of the algorithm, rather it is approached in a gradient descent type fashion. This allows for the method to scale to larger more complex networks more easily.

As illustrated, updated penalties 120 is used by MDP learning module 108 in an iterative fashion. MDP learning module 108 may update the optimal agent policies 110 based on the updated penalties 120, and the iterative process may continue for a number of iterations to converge on optimal policies and penalties.

Average 122 determines the averages of the rewards 114 and updated penalties 120 (costs). In some embodiments, rather than considering the final updated penalties 120 as being optimal, an average, or weighted average, over the iterations may be used.

The above description may be formalized mathematically as follows. Let N ={1, 2, . . . , n} be the set of agents (indexed by i), e.g., firms or households, and M ={1, 2, . . . , m} be the set of resources (indexed by j), e.g., solar power or oil. Since agents are strategic, we model each agent as facing a Markov Decision Process (MDP)Mi, modified to account for its resources contributions.

Formally, an MDP with resource contributions is a tuple Mᵢ={SᵢAᵢTᵢrᵢgᵢ}. Here sᵢ ∈ Sᵢ is the agent state and aᵢ ∈ Aᵢ is its action. The transition function Tᵢ(sᵢ′|sᵢ, aᵢ) gives the probability of moving from state sᵢ to sᵢ′ given action aᵢπrᵢ:Sᵢ×Aᵢ→ [symbol] is the reward function. The resource contribution function gᵢ:Sᵢ×Aᵢ→ [symbol] , gᵢ(sᵢaᵢ)=(g_{i,j}(sᵢ, aᵢ))_{j∈M′}is an m-dimensional vector that encodes how much agent i adds to each resource j ∈ M.

A resource-constrained multi-agent Markov decision process (CMMDP) is the tuple M={N, M (Mᵢ)_{i∈N}, (Cⱼ)_{j∈M}}, where Cⱼ≥0 are resource capacities, one for each resource j.

Assuming the transitions, policies, rewards, and resource contribution functions for each agent's MDP are independent and only depend on the state and action of that agent, e.g., T(s′|s, a)=ΠᵢT(sᵢ′|sᵢ, aᵢ), where the joint state of all agents is denoted by s=(sᵢ)_{j∈N} and the action profile of all agents by a=(aᵢ)_{i∈N}. Furthermore, each agent samples actions using a policy i.e., a distribution over its actions. Let π=(πᵢ)_{i∈N} denote the profile of all policies and Πᵢ denote the set of all policies for agent i. Also, the initial state is sampled from the distribution s⁰˜d₀.

The resource capacities couple the agent MDPs, i.e., the total contribution to each resource j across all the agents and all the steps are constrained by the resource capacities in expectation:

$${𝔼}_{{d}_{, 0 , T , π}} [ {\sum }_{i = 1}^{n} {\sum }_{k = 0}^{K} {g}_{i , j} ( {s}_{i}^{k} {a}_{i}^{k} ) ] \leq {C}_{j} .$$

Here, the expectation is with respect to the probability distribution induced on the CMMDP.

A problem may be formulated to maximize the total reward for all the agents subject to the capacity constraints, i.e.,

$${max}_{{π}_{i} ∈ {\prod }_{i} ∀ i} {𝔼}_{{d}_{0 ,} T , π} [ {\sum }_{i = 1}^{n} {\sum }_{k = 0}^{K} {r}_{i} ( {s}_{i}^{k} {a}_{i}^{k} ) ] ,$$

such that constraint (1) holds for all j,

Since the agents are strategic, the goal is to find the optimal policies π* that maximize social welfare and optimize the corresponding Lagrange multipliers λ*=(λⱼ)_{j∈M}. Given prices λ, consider auxiliary MDPs \tilde{M}ᵢ(λ)=(SᵢAᵢTᵢ\tilde{r}ᵢ), where the price-weighted rewards are \tilde{r}ᵢ(sᵢaᵢ; λ)=rᵢ(sᵢaᵢ)−Σⱼλⱼg_{i,j}(ᵢaᵢ). The policies πᵢ* are optimal policies for the auxiliary MDP \tilde{M}ᵢ(λ*) for each agent i, thus providing an incentive to the strategic agents to adhere to the policy πᵢ*. From an optimization perspective, the λ enforce the constraints.

For technical purposes, assume that the dual variables λ* corresponding to an optimal primal solution π* are bounded by a universal constant λⱼ*≤B, ∀j. This is guaranteed, e.g., if the rewards rᵢ and resource contributions g_{i,j} are bounded [43, 26]. First note that the optimization problem satisfies strong duality; its Lagrangian is:

$$ℒ ( λ , π ) = {\sum }_{i = 1}^{n} {\sum }_{k = 0}^{K} {𝔼}_{{d}_{0} , T , π} [ {r}_{i} ( {s}_{i}^{k} {a}_{i}^{k} ) ] - {\sum }_{j = 1}^{m} {λ}_{j} [ {\sum }_{i = 1}^{n} {\sum }_{k = 0}^{K} {𝔼}_{{d}_{0} , T , π} [ {g}_{i , j} ( {s}_{i}^{k} {a}_{i}^{k} ) ] - {C}_{j} ] , \\ for {λ}_{j} \geq 0 and {π}_{i} ∈ {\prod }_{i}^{M} .$$

Similarly, the Lagrangian [symbol] (λ, π^{W}) may be defined where instead of the Markov policies πᵢ there is a mixed deterministic Markov policy πᵢ^{W} for each agent i, and the expectation is with respect to the probability distribution induced by these mixed deterministic Markov policies. Let V denote the optimal value of the optimization problem:

$$\begin{matrix}V = {max}_{{π}_{i} ∈ {\prod }_{i}^{M}} {min}_{0 \leq {λ}_{j} \leq B} ℒ ( λ , π ) = {max}_{{π}_{i}^{w} ∈ Δ ( {\prod }_{i}^{D} )} {min}_{0 \leq {λ}_{j} \leq B} ℒ ( λ , {π}^{w} ) \\ = {min}_{0 \leq {λ}_{j} \leq B} {max}_{{π}_{i}^{w} ∈ Δ ( {\prod }_{i}^{D} )} ℒ ( λ , {π}^{w} ) = {min}_{0 \leq {λ}_{j} \leq B} {max}_{{π}_{i} ∈ {\prod }_{i}^{M}} ℒ ( λ , π )\end{matrix}$$

Here, the first equality follows from the minimax formulation of the constrained optimization problem, the second and last equality follows from the equivalence between Markov policies and mixed deterministic policies, and the third equality follows from strong duality: it holds because the set of deterministic Markov policies is finite, the sets Δ(Πᵢ^{D}) are compact, and the Lagrangian is bilinear in mixed deterministic policies and dual variables (Sion's minimax theorem).

A system may determine an optimal strategy for agents (e.g. performed by MDP learning module 108). A player has a no-regret learning strategy if its regret (i.e., average difference between the realized and optimal payoffs) grows sublinearly, irrespective of the opponent's strategy. If all players are no-regret learners, then the average payoff converges to the value V. Example no-regret strategies includes follow-the-perturbed-leader, multiplicative-weights updates. With no-regret learning it is guaranteed that the average policies converge to a Nash equilibrium, but the policies for setting λ, πᵢ themselves may not converge.

Now assume a simulator (e.g., simulator 112) to get Monte Carlo estimates of the expected rewards and resource contributions in the above equation. This avoids having to know the transitions T analytically to compute the true expected rewards and resource contributions, which is unrealistic for many real-world problems, especially with many heterogeneous agents and capacity constraints.

To avoid computing empirical averages, one could replace no-regret learning by optimistic gradient-based methods with last-iterate-convergence guarantees, but these might not converge at all when using RL. In practice, computing the average prices λ̅ across iterations is simple (eg., average 122), and may be used as the optimal prices.

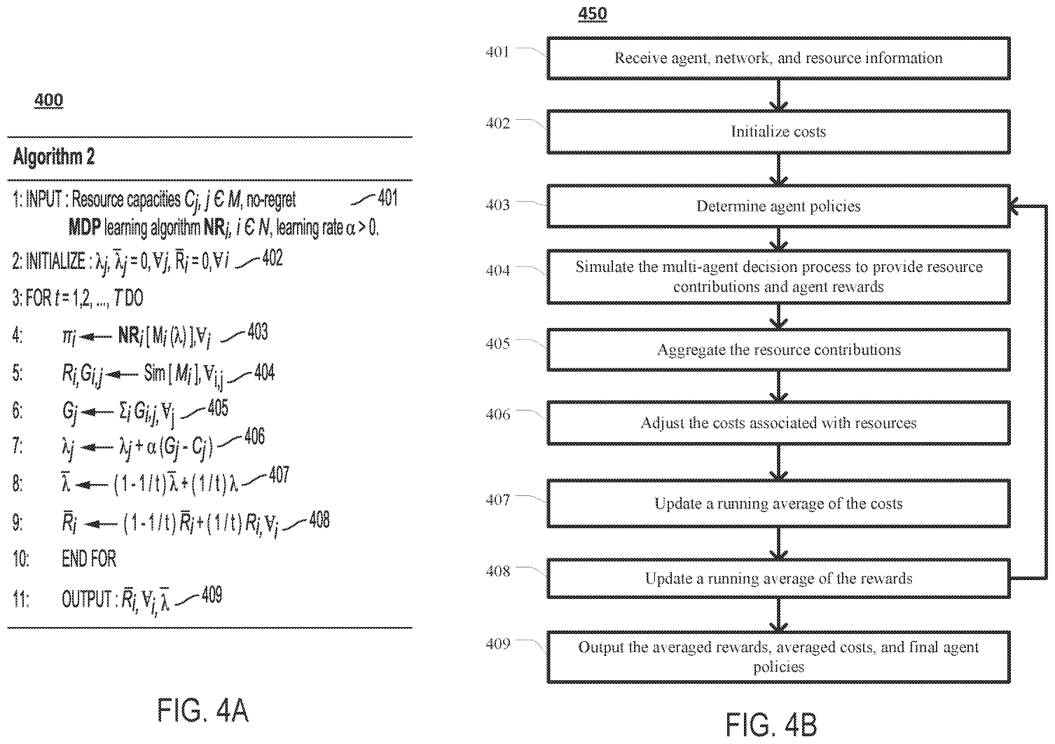

For the planner, online gradient descent may be used, which is no-regret. For the agents, a no-regret algorithm may be used for each agent to solve each auxiliary MDP Mᵢ[λ^{t}], given prices set by the planner. Note that because of the decoupled structure of CMMDP, a system can solve for each agent individually. In particular, if each agent uses no-regret learning, then the “aggregate player” opposing the planner in the zero-sum game view has a no-regret strategy. The system may use (deep) RL for each agent's no-regret strategy NRᵢ; various RL algorithms have been shown to be no-regret. An embodiment of this method is described further with respect to FIG. 4 and elsewhere herein.

### Computer and Network Environment

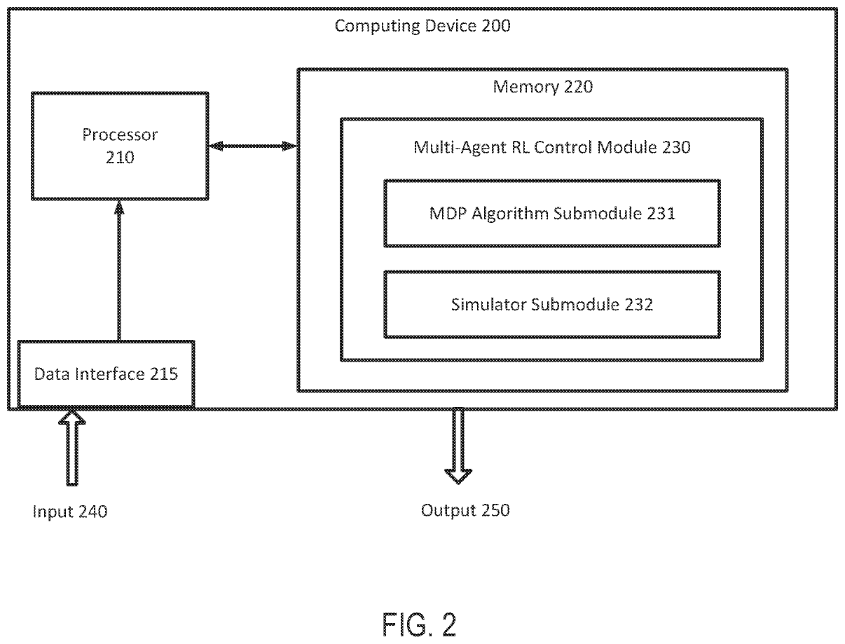

FIG. 2 is a simplified diagram illustrating a computing device implementing the decision process solving method described in FIG. 4 according to one embodiment described herein. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for multi-agent RL control module 230 that may be used to implement and/or emulate the systems and models, and/or to implement any of the methods described further herein. An multi-agent RL control module 230 may receive input 240 such as a network with agents, constraints, resources, etc. via the data interface 215 and generate an output 250 which may be optimized resource costs.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as network information, from a user via the user interface.

In some embodiments, the multi-agent RL control module 230 is configured to determine optimal strategies (e.g., resource costs), agent policies, and/or associated rewards. The multi-agent RL control module 230 may further include an MDP algorithm submodule 231 (e.g., similar to MDP learning module 108 in FIG. 1) and simulator submodule 232 (e.g., similar to simulator 112 of FIG. 1). In one embodiment, the multi-agent RL control module 230 and its submodules 231 and 232 may be implemented by hardware, software and/or a combination thereof.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

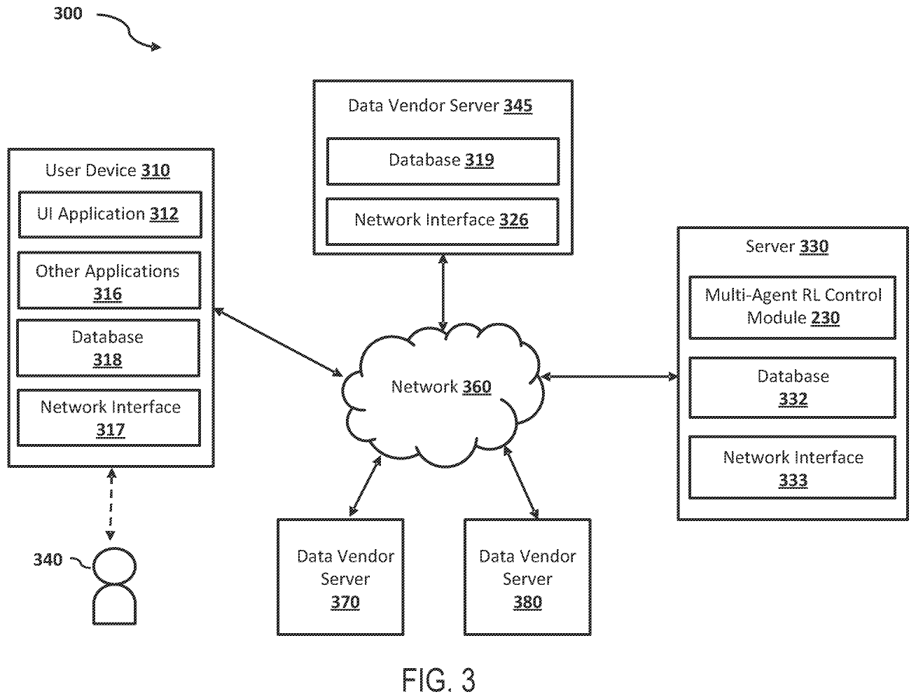

FIG. 3 is a simplified block diagram of a networked system suitable for implementing the Decision Process solving framework described in FIG. 4 and other embodiments described herein. In one embodiment, block diagram 300 shows a system including the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., Google Glass®), other type of wearable computing device, implantable communication devices, and/or other types of computing devices capable of transmitting and/or receiving data, such as an Ipad® from Apple®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating costs, agent policies, and/or rewards from the server 330 and display the message via the UI application 312. In addition to, or instead of, displaying the message, user device 310 may perform some action based on the received information. For example, access to a particular communication network resource may be controlled by the received information (e.g., based on the cost). In other embodiments, user device 310 may include additional or different modules having specialized hardware and/or software as required.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view outputs of the multi-agent RL control module 230.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide network/agent datasets including initial costs, resources, network constraints, etc. to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the multi-agent RL control module 230 and its submodules described in FIG. 1. In some implementations, multi-agent RL control module 230 may receive data from database 319 at the data vendor server 345 via the network 360 to generate optimized costs, policies, and/or rewards. The generated costs, policies, and/or rewards may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the multi-agent RL control module 230. In one implementation, the database 332 may store previously generated costs, policies, and/or rewards, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

FIG. 4A provides an example pseudo-code segment illustrating an example algorithm 400 for a method of optimization based on the framework shown in FIGS. 1-3. FIG. 4B provides an example logic flow diagram illustrating a method of optimization according to the algorithm 400 in FIG. 4A, according to some embodiments described herein. One or more of the processes of method 450 may be implemented, at least in part, in the form of executable code stored on non-transitory, tangible, machine-readable media that when run by one or more processors may cause the one or more processors to perform one or more of the processes. In some embodiments, method 450 corresponds to an example operation of the multi-agent RL control module 230 (e.g., FIG. 2) that performs multi-agent network optimization.

As illustrated, the method 450 includes a number of enumerated steps, but aspects of the method 450 may include additional steps before, after, and in between the enumerated steps. In some aspects, one or more of the enumerated steps may be omitted or performed in a different order.

At step 401, a system (e.g., computing device 200 of FIG. 2) receives agent, network, and resource information. Information may include resource capacity constraints (i.e., constraints on the amount of resources that may be contributed by the agents). In some embodiments, the resource capacity constraints may not be a hard limit, but rather a limit on the expected value of the contributions. A convention is that consumption is a positive resource contribution g_{i,j} and production is a negative resource contribution, so that an upper-bound on resource contributions are capacity constraints. Fixed resources simply only have positive resource contributions. The condition that the goods produced should be more than the goods consumed in a closed economy means the capacity constraints for firm resources is zero. On the other hand, some fixed resource availability may be assumed for each fixed resource and use a capacity constraint for them. Resource information may include identification of all the resources of interest, available amounts etc. Agent information may include possible states, actions, etc. that may define an MDP, and agent policies. Different resource contribution capabilities may also be received. At step 401 the system may also receive an indication of a learning rate that is to be applied to the optimization process as discussed below. Other information relating to the agent, network, and resources may be provided to the system as necessary for the optimization.

At step 402, the system initializes costs. In some embodiments, the costs associated with each resource are initialized to 0. The reward value for each agent may also be initialized to 0. The following steps may be performed iteratively for a predefined number of iterations.

At step 403, the system determines agent policies (e.g., by MDP algorithm submodule 231 of FIG. 2). This may be done using a no-regret MDP learning algorithm. In some embodiments, the MDP learning algorithm is not “no-regret.” The learning algorithm may be defined or otherwise indicated at step 401 as an input to the system. In practice, a number of different algorithms may be used at this step. The result of using the MDP learning algorithm is each agent, or a batch of a subset of the agents, determines an optimized MDP policy.

At step 404, the system simulates the multi-agent decision process to provide resource contributions and agent rewards (e.g., by simulator submodule 232 of FIG. 2). The simulation is performed using information received at step 401, and using policies as determined at step 403. The simulation provides reward values associated with each agent, and the amount of resource contributions for each resource by each agent. The simulation may be performed over a predetermined number of time steps.

At step 405, the system aggregates the resource contributions. For example, the resource contributions by each agent for each resource may be summed to provide the total resource contributions for each resource.

At step 406, the system adjusts the costs associated with resources. For example, if a particular resource contribution value is higher than the associated resource capacity (indicating that the resource had a higher contribution amount than desired), then the cost associated with that resource may be incremented. The amount by which the costs are incremented may be proportional to the difference between the resource contribution and resource capacity constraint, as scaled by the learning rate. Similarly, in instances where contribution was smaller than capacity, the resource cost may be decremented rather than incremented. Since this step is incremental, this allows for a system to perform this process iteratively, and not necessarily include all agents and all resources at each iteration. Agents and resources may instead contribute to the overall optimization in batches. This may be considered a form of gradient descent.

At step 407, the system updates a running average of the costs. In some embodiments where the cost at the final iteration is used as the optimized cost, this step is not necessary. However, the system may rather use an averaged cost over the training iterations as the optimal cost.

At step 408, the system updates a running average of the rewards. Similar to the costs, the rewards associated with the costs may have an average which is used in relation to the averaged cost. If the number of iterations is complete, the system may continue to step 409, otherwise it will return to step 403 and continue the iterative process.

At step 409, the system outputs the averaged rewards, averaged costs, and final agent policies. In some embodiments, the rewards and/or costs are not averaged but are rather the values determined at some iteration of the process described here. Averaging agent policies across iterations is in general more complicated, and it is more efficient to not average the policies. In some embodiments, however, an averaged version of the agent policies may be used. The output rewards, costs, and policies (or a subset thereof) may be used by the system in making a decision. For example, in the communication network context, a network device may route network traffic according to costs associated with network resources.

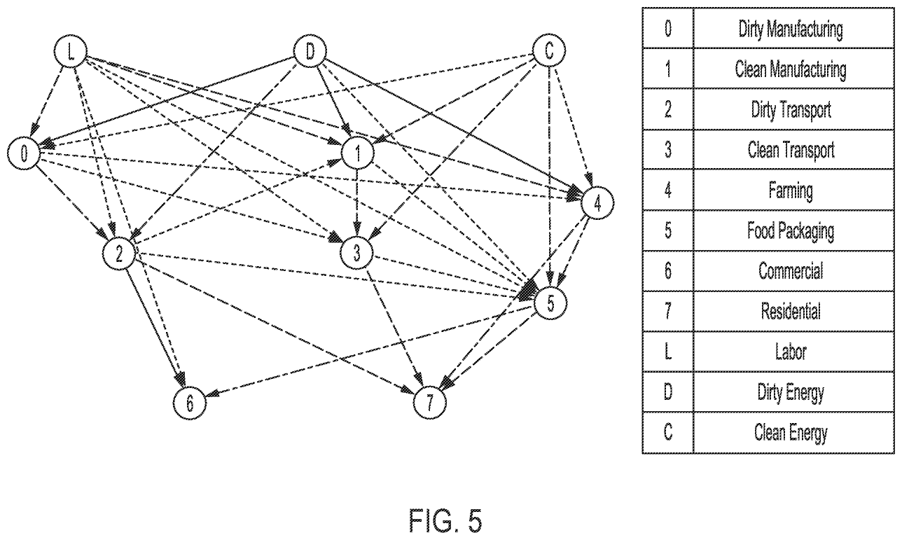

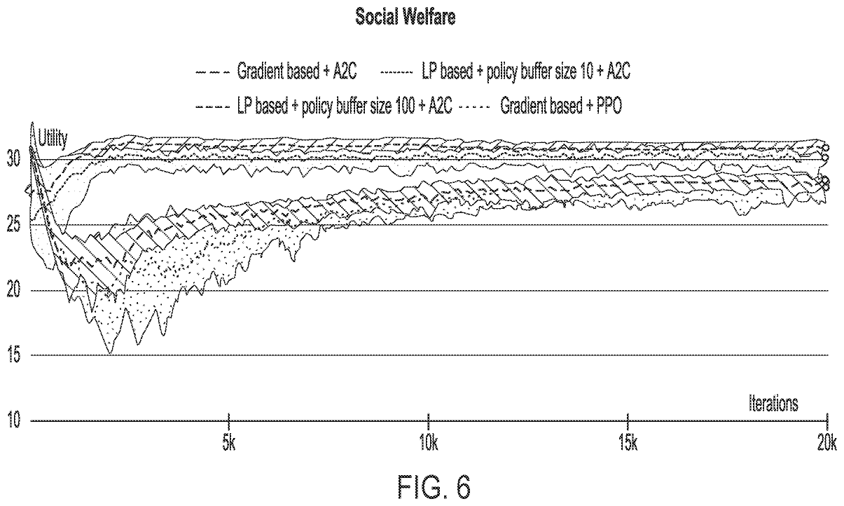

FIG. 5 illustrates an exemplary network according to some embodiments. Nodes denote different agents and resources, and edges denote dependence of agents on other agents and resources for consumption. As shown, agents may be heterogenous, each representing a different type of resource consumer/provider with different characteristics. The agents described in the key of FIG. 5 are exemplary, and are in the context of energy producers and users. The example performance described with respect to FIGS. 6-12 are with reference to a similar network.

FIGS. 6-9B provide charts illustrating exemplary performance of different embodiments described herein. FIGS. 6-9B are in the context of an economic network with multiple agents of two types: firms and households. Let {Firm₁, . . . , Firmₙ₁} and {Households, . . . , Householdₙ₂} denote the set of firms and households, respectively. Firms and households consume and/or produce commodities: resources and goods. There are fixed resources: Labor, DirtyEnergy, CleanEnergy, and Greenlnvestment. There are different types of goods, one for each firm. The firms (households) consume commodities to produce goods (gain consumption utility). Assume that each agent i can consume from a subset of commodities I(1) only. This defines a network [symbol] =(N, ε) with nodes: N={Firm₁, . . . , Firmₙ₁, Household₁, . . . , Householdₙ₂, Labor, DirtyEnergy, CleanEnergy}, and the directed edge set ε with edges going from I(1) to node i denoting flow of goods in the economy. Note that a firm node indicates both the firm agent and the goods produced by that firm. Assume that each agent decides on the amount of green investments it wants to do. These investments lead to changes in their production and consumption function by modifying their technology factors and elasticity coefficients. Assume heterogeneity amongst the agents. Roughly speaking, green investments lead to reduced elasticity coefficients corresponding to dirty goods and increased elasticity coefficients corresponding to clean goods.

### Example Simulation Illustrations

The results in FIGS. 6-9B represent a simulation of this “world” simulated across K time steps, where each agent's state is characterized by its production/consumption function and its actions decide its commodity purchases and green investment. The transition T depends on the level of green investments and the resulting changes in production and consumption. The base reward for each household agent is given by its consumption utility. The base rewards for the firms are zero, but the modified rewards for the firms in the auxiliary MDPs (after the policymaker imposes resource prices) are non-zero, i.e., firm profits. There is one resource node for each good and four resource nodes for Labor, DirtyEnergy, CleanEnergy, and GreenInvestment. By solving the CMMDP we get the prices for all resources. The modified rewards are profits for the firms and utility for the households, which depends on consumption minus their purchase costs.

FIG. 6 illustrates consistency between an LP solver and the method described at FIG. 4. As shown, the gradient based iterative algorithm tends to the optimal social welfare achieved by the LP based algorithm. As expected, there is an improvement in performance if larger policy buffers are used in the iterative LP algorithm. As shown, the meta-algorithm and LP based algorithm are consistent. The LP based algorithm shows faster convergence in a small network. This is expected since the LP solver finds local optimal prices whereas the meta-algorithm takes gradient based steps towards the optimal.

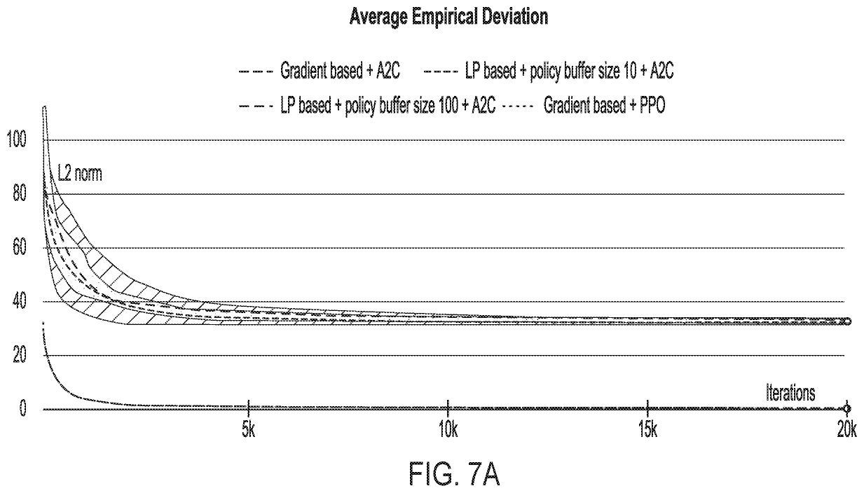

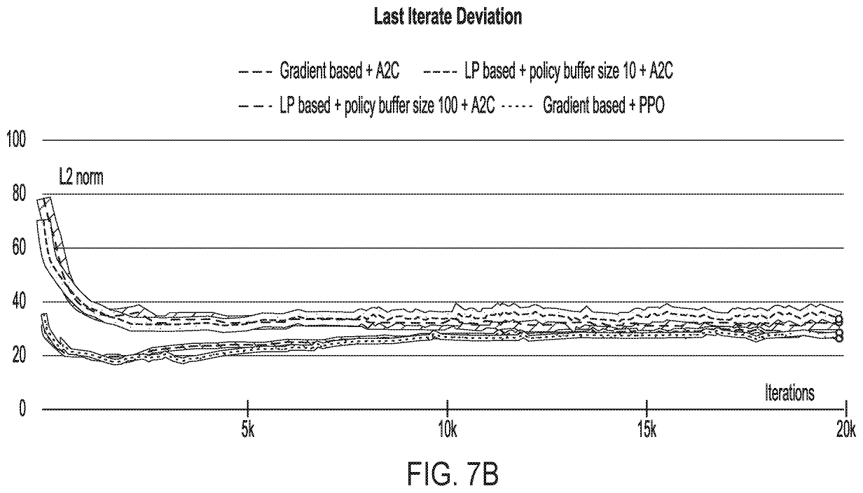

FIGS. 7A and 7B illustrate that the average deviation of resource contributions from the capacity constrained feasible region tends to zero for the meta-algorithm, as predicted by theory. On the other hand, the iterative LP algorithm does not have such guarantees and it is shown that it indeed does not tend to zero on average. The LP based solution achieves feasible solution by mixing appropriately over different policies in the policy buffer. Specifically, FIG. 7A illustrates the average deviation from feasible domain. The average policy converges (the deviation from the feasible domain converges to zero) for the meta-algorithm of some embodiments (e.g., as discussed at FIG. 4) but not for the iterative LP algorithm, as predicted by theory. This shows the meta-algorithm is more effective in practice. FIG. 7B illustrates deviation from feasible domain of last-iterate Markov policies. As shown, the last iterate does not stabilize (the deviations do not converge to zero) for the meta-algorithm, similar to the LP algorithm.

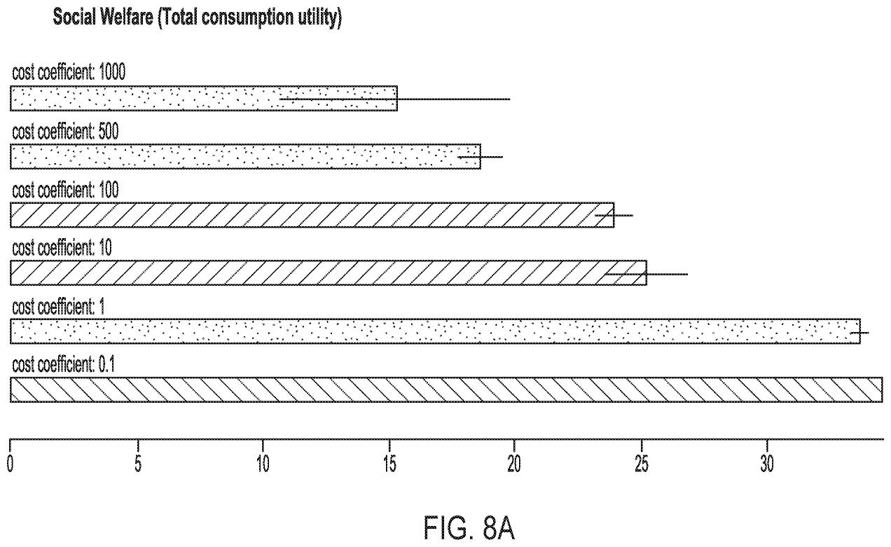

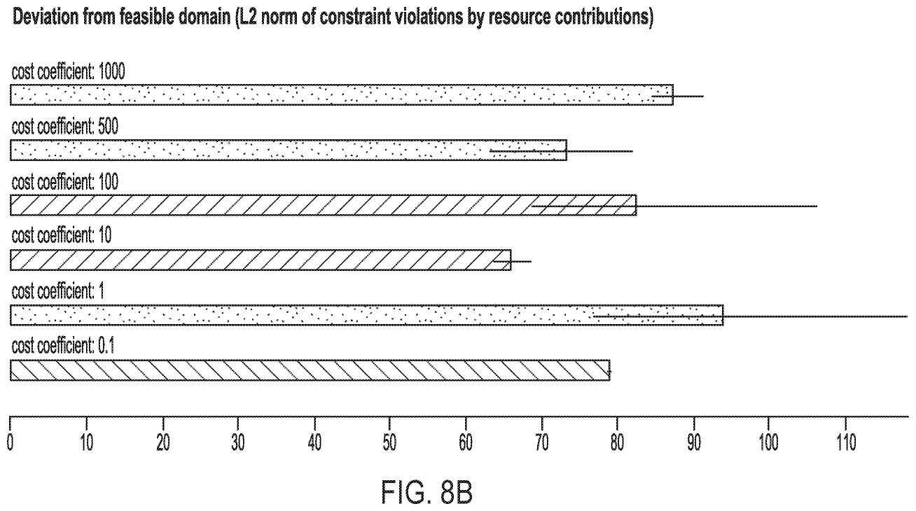

FIGS. 8A and 8B illustrate results using different cost coefficients. As shown, non-targeted policies that do not charge agents individually based on their resource contributions converge to solutions with high deviation from the feasible region. This is typical in multi-agent settings where strategic agents' actions need to be aligned. As expected, higher cost coefficients give lower social welfare. But more interestingly, the deviation from the feasible domain is much worse than the LP base method or the meta-algorithm as shown. This suggests that targeted pricing and the algorithm where the prices and policies are learned in an iterative manner is important in finding solutions that satisfy the capacity constraints.

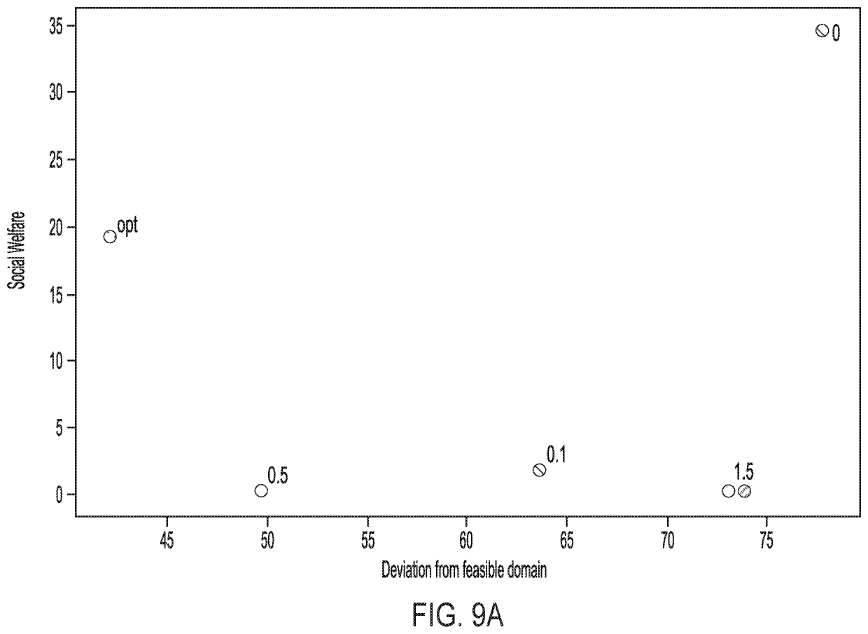

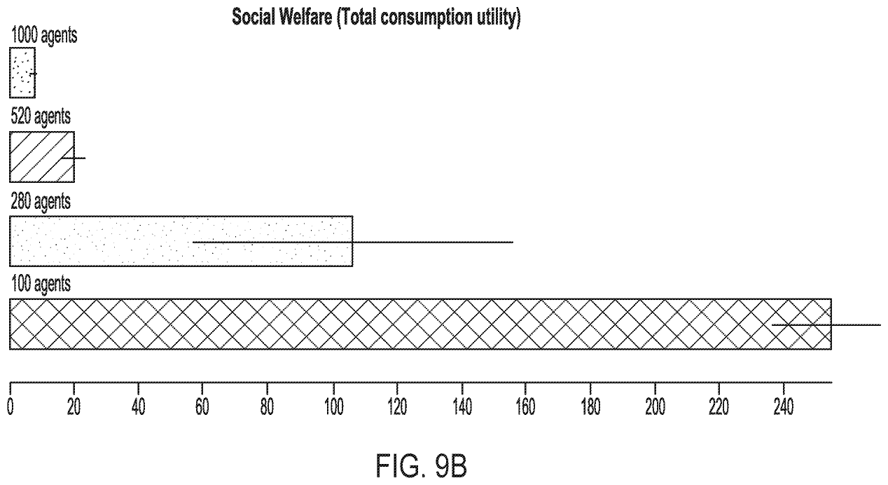

FIG. 9A illustrates results from experiments with fixed prices λ. For fixed pricing with optimal prices, it is shown that the deviation from the feasible domain is similar to the one achieved by the iterative LP algorithm for each individual policy. The social welfare is sub-optimal as compared to the one achieved by iterative algorithms. This further supports the understanding that the iterative process is important not only in price discovery but also learning the optimal policies that satisfy capacity constraints. With flat pricing, it is shown that the deviation from the feasible domain is similar to the one achieved using non-targeted penalties. When the flat prices are zero then social welfare ≈35, which is the maximum possible in the absence of capacity constraints. For most other reasonable values of pricing ranging from 0.1 to 5, the results show very low social welfare (the optimal prices range from 0.25 to 1.15). The experiments converge to low social welfare for a flat pricing of 0.1. For a flat pricing of 0.5 or higher it converges to zero, indicating that the economy shuts down at prices that are too high.

FIG. 9B illustrates that social welfare decreases as we increase the number of nodes with fixed number of households and fixed resource capacities for labor, dirty energy, clean energy and green investment.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A system for policy control in a dynamic system via a multi-agent reinforcement learning network, the system comprising:
a memory that stores network information and a plurality of processor-executable instructions;
a communication interface that receives characteristics of a plurality of agents, and constraints for a plurality of resources of a dynamic system; and
one or more hardware processors that read and execute the plurality of processor-executable instructions from the memory to perform operations including:
allocating initial values for a plurality of costs associated with the plurality of resources; and
performing, at an iterative step:
determining policies for the plurality of agents that optimize respective reward values based on the plurality of costs, and the characteristics of the plurality of agents;
simulating a multi-agent decision process using the determined policies, the plurality of costs, and the characteristics of the plurality of agents, thereby generating respective reward values and aggregated resource contribution values;
incrementing or decrementing the plurality of costs based on the constraints and the aggregated resource contribution values;
updating a final reward value based on the generated respective reward values; and
updating a final plurality of costs based on the plurality of costs;
continuing performing the iterative step for a predetermined number of iterations; and
outputting the final reward value and the final plurality of costs.

2. The system of claim 1, wherein determining policies for the plurality of agents includes:
determining policies for the plurality of agents that maximizes the respective reward values subject to the constraints for the plurality of resources of the dynamic system.

3. The system of claim 2, wherein determining policies for the plurality of agents includes:
computing a Lagrangian having a mixed deterministic Markov policy for each agent, and
taking an expectation with respect to a probability distribution of the respective reward values induced by the mixed deterministic Markov policy.

4. The system of claim 1, wherein the final plurality of costs is a weighted average of the costs over multiple iterative steps.

5. The system of claim 1, wherein the final reward value is a weighted average of the respective reward values over multiple iterative steps.

6. The system of claim 1, wherein:
the communication interface further receives a learning rate value, and
the incrementing or decrementing is further based on the learning rate value.

7. The system of claim 1, wherein the incrementing or decrementing is based on respective differences between the constraints and the aggregated resource contribution values associated with respective constraints.

8. The system of claim 1, wherein determining policies for the plurality of agents is performed on a subset of the plurality of agents at each time step.

9. A non-transitory machine-readable medium comprising a plurality of machine-executable instructions which, when executed by one or more processors, are adapted to cause the one or more processors to perform operations comprising:
receiving characteristics of a plurality of agents, and constraints for a plurality of resources of a dynamic system;
allocating initial values for a plurality of costs associated with the plurality of resources; and
performing, at an iterative step:
determining policies for the plurality of agents that optimize respective reward values based on the plurality of costs, and the characteristics of the plurality of agents;
simulating a multi-agent decision process using the determined policies, the plurality of costs, and the characteristics of the plurality of agents, thereby generating respective reward values and aggregated resource contribution values;
incrementing or decrementing the plurality of costs based on the constraints and the aggregated resource contribution values;
updating a final reward value based on the generated respective reward values; and
updating a final plurality of costs based on the plurality of costs; and
continuing performing the iterative step for a predetermined number of iterations; and
outputting the final reward value and the final plurality of costs.

10. The non-transitory machine-readable medium of claim 9, wherein determining policies for the plurality of agents includes:
determining policies for the plurality of agents that maximizes the respective reward values subject to the constraints for the plurality of resources of the dynamic system.

11. The non-transitory machine-readable medium of claim 10, wherein determining policies for the plurality of agents includes:
computing a Lagrangian having a mixed deterministic Markov policy for each agent, and
taking an expectation with respect to a probability distribution of the respective reward values induced by the mixed deterministic Markov policy.

12. The non-transitory machine-readable medium of claim 9, wherein the final plurality of costs is a weighted average of the costs over multiple iterative steps.

13. The non-transitory machine-readable medium of claim 9, wherein the final reward value is a weighted average of the respective reward values over multiple iterative steps.

14. The non-transitory machine-readable medium of claim 9, wherein the operations further comprise receiving a learning rate value, and the incrementing or decrementing is further based on the learning rate value.

15. The non-transitory machine-readable medium of claim 9, wherein the incrementing or decrementing is based on respective differences between the constraints and the aggregated resource contribution values associated with respective constraints.

16. The non-transitory machine-readable medium of claim 9, wherein determining policies for the plurality of agents is performed on a subset of the plurality of agents at each time step.

17. A method of policy control in a dynamic system via a multi-agent reinforcement learning network, the method comprising:
receiving, via a data interface, characteristics of a plurality of agents, and constraints for a plurality of resources of a dynamic system;
allocating initial values for a plurality of costs associated with the plurality of resources; and
performing, at an iterative step:
determining policies for the plurality of agents that optimize respective reward values based on the plurality of costs, and the characteristics of the plurality of agents;
simulating a multi-agent decision process using the determined policies, the plurality of costs, and the characteristics of the plurality of agents, thereby generating respective reward values and aggregated resource contribution values;
incrementing or decrementing the plurality of costs based on the constraints and the aggregated resource contribution values;
updating a final reward value based on the generated respective reward values; and
updating a final plurality of costs based on the plurality of costs; and
continuing performing the iterative step for a predetermined number of iterations; and
outputting the final reward value and the final plurality of costs.

18. The method of claim 17, wherein determining policies for the plurality of agents includes:
determining policies for the plurality of agents that maximizes the respective reward values subject to the constraints for the plurality of resources of the dynamic system.

19. The method of claim 18, wherein determining policies for the plurality of agents includes:
computing a Lagrangian having a mixed deterministic Markov policy for each agent, and
taking an expectation with respect to a probability distribution of the respective reward values induced by the mixed deterministic Markov policy.

20. The method of claim 17, wherein the final plurality of costs is a weighted average of the costs over multiple iterative steps.
